(19) United States
(12) Patent Application Publication
(10) Pub. No.: US 2004/0245932 A1
(43) Pub. Date: Dec. 9, 2004

(54) Microwave generator with virtual cathode

(76) Inventor: Alain-Joseph Durand, Velizy Villacoublay (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/488,792

(22) PCT Filed: Sep. 27, 2002
(86) PCT No.: PCT/FR02/03310

(30) Foreign Application Priority Data
Sep. 28, 2001 (FR) 01/12547

(51) Int. Cl. H01J 25/02

(52) U.S. Cl. 315/5.14; 315/5.16; 331/79

(57) ABSTRACT

The subject of the present invention is a very high-power microwave generator using the virtual cathode effect.

The microwave generator (60) comprises an emitter (62) capable of producing electrons in a microwave output circuit (64, 66), the quantity of electrons emitted being sufficient to cause a regular variation in the electron density in the output microwave circuit, the circuit converting the kinetic energy of the electrons into microwave energy in a resonant mode, the electron emitter emitting the electrons in several regions of the microwave circuit that exhibit field extrema (Exa1, Exa2, Exa3) of the resonant mode.

The subject of the present invention is a very high-power microwave generator using the virtual cathode effect.

To generate high instantaneous microwave power levels, it is known to use electron tubes called vircators. Vircators are oscillator electron tubes of very high power that employ very intense electron beams capable of forming a virtual cathode.

In an electron beam, running through an essentially metal tube or chamber, a potential hollow is created whereby the electrons do not have quite the velocity that corresponds to their initial acceleration, particularly in the case of the electrons at the center of the beam. When the beam current becomes high, the potential hollow at the center ends up being such that it no longer permits electrons to flow, and the beam becomes hollow. For an even higher current I, greater than a certain critical current (ISIc), even the electrons at the edge no longer flow—they undergo path reflections—and the accumulation of electrons is called a virtual cathode, which occurs at the place of the reflection.

A virtual cathode is unstable as the amplitude of its potential hollow and its position oscillate, and this results in a periodic variation in the number of electrons reflected or transmitted.

A device such as a vircator makes it possible to create electromagnetic fields with high microwave power levels in a small volume.

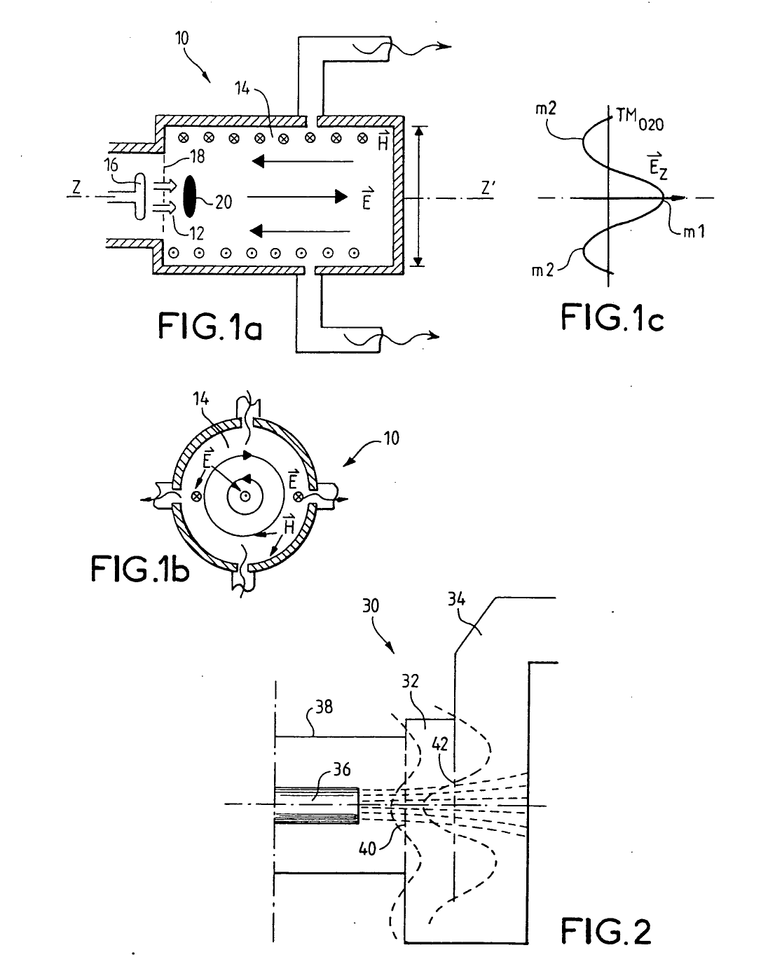

FIG. 1a shows a sectional drawing of a vircator 10 of the prior art. In the vircator 10, a very short electron beam 12 is sent into a cylindrical chamber 14, generally by field emission from a cold cathode 16 (tips, velvet, flat surface, etc.), the anode being a very thin metal foil 18 or a metal grid.

The electrons extracted from the cathode by the potential existing between the anode and the cathode mostly pass through this metal foil 18 or grid, and very quickly form behind it a virtual cathode 20, the more easily if the chamber 14 is a little wider at this point. A number of electrons undergo a to-and-fro motion between the actual cathode 16 and the virtual cathode 20 in the form of microwave oscillation. This oscillation gives rise to electromagnetic radiation in one of the modes defined by the geometry of the assembly of components making up the vircator.

Another source of radiation, albeit a more modest one, arises from the displacement or vibration of the virtual cathode 20 itself.

FIG. 1b shows a sectional view of the vircator 10 in a plane perpendicular to the axis ZZ′ of revolution of the cylindrical chamber 14 and FIG. 1c represents the variation in the field E in the chamber in a plane passing through the ZZ′ axis of the chamber. In this embodiment of the vircator of FIG. 1a, the resonance mode is such that the field E in the chamber passes through a first maximum m1, which we will hereafter call a first extremum m1, along the ZZ′ axis of the chamber 14 and another extremum m2 in the opposite direction to the first, of circular shape around the first extremum.

The orders of magnitude of the energies involved in a vircator are the following:

cathode voltage: Vₖ=700 kV;

cathode current: Iₖ=30 kA;

output power: Pₒᵤₜ=600 MW;

width of the emission pulse Pₜ:τ=60 ns;

efficiency=2.8%.

As certain requirements (air space interference) require very high power levels, the first idea is therefore to increase the beam power VₖxIₖ. However, any increase in the voltage increases the probability of an arc along the insulators and in the tube, unless operation is with pulses of shorter τ. It therefore follows that if the power increases, τ decreases and the energy of the pulse Pₜ increases only very slightly.

The second idea is to increase the efficiency of the vircator. It is actually possible, by using a feedback vircator (FV), to double the efficiency and therefore the power.

FIG. 2 shows a diagram explaining the principle of a feedback virtual-cathode microwave generator 30 of the prior art or feedback vircator (FV) 30.

The feedback vircator 30 includes a resonant cavity 32 of low height coupled to a waveguide 34. A cathode 36 of the electron gun 38 of the vircator injects a high-current electron beam through a first grid 40 into the resonant cavity 32 and then through a second grid 42 into the waveguide 34. The height of the waveguide 34 is sufficient, when the cathode current Iₖ is greater than a critical value I_{kc}, to create a virtual cathode in the waveguide that repels the incident electrons, the to-and-fro motion of which generates microwaves. The signal generated in the waveguide 34 excites the resonant cavity 32 and the microwave fields in the cavity modulate the beam energy and therefore group the beam into packets. The oscillator thus produced is a feedback vircator. There is a value of phase difference between the fields in the resonant cavity and the fields in the waveguide that optimizes the efficiency.

However, in certain cases the microwave power levels thus obtained are still insufficient, and the present invention proposes a means of increasing them further, while maintaining the pulse widths τ, or even broadening them.

Of course, to do this, there is no question of increasing the high voltage Vₖ on account of the inopportune arcs and breakdowns that would shorten τ and damage the tube. The scientific literature on these pulse shortening effects is quite extensive.

If Vₖ cannot be increased, it remains to increase Iₖ. To do this:

the anode may be brought closer and more current may be extracted; however, since the frequency varies, schematically, so as to be inversely proportional to the distance d_{KG} between cathode and anode, the operating frequency is higher and in any case different. This solution does not solve the problem posed, the more so as, in general, the power decreases with frequency (more compact resonant volumes) and as the closure of the space between cathode and anode, separated by d_{KG}, by the plasma emitted both by the anode and the cathode takes place earlier, resulting in a reduction in pulse width τ;

it is also possible to increase the area of the cathode. However, we should point out that electrons undergoing to-and-fro motion between the actual cathode and the virtual cathode radiate only if they are in a maximum (extremum), or near the maximum, of the electrical component E of the electromagnetic field of a resonance mode of the cathode/anode space. It is therefore not possible to increase this area indefinitely and, in general, it is already, in this sense, optimized.

To increase the emission power of a vircator while keeping the same pulse widths τ, or even broadening them, the invention proposes a microwave generator comprising an emitter capable of producing electrons in a microwave output circuit, the quantity of electrons emitted being sufficient to cause a regular variation in the electron density in the output microwave circuit, the circuit converting the kinetic energy of the electrons into microwave energy in a resonant mode, characterized in that the electron emitter emits the electrons in several regions of the microwave circuit that exhibit field extrema of the resonant mode.

The emitter is an electron gun comprising several cathodes so as to produce several electron beams and according to a main feature of the invention, each of the beams being emitted in a field extremum region of the resonant mode of the microwave circuit.

It is a first object of this invention to increase the microwave emission pulse power of the vircator without increasing the cathode currents or the anode voltages.

It is a second object of this invention to increase the efficiency of the conversion of the electron energy into electromagnetic pulse energy needed in some applications.

It is a third object of this invention to increase the width of the electromagnetic pulse in order to bring it closer to the width of the cathode/grid (or cathode/anode) voltage pulse.

In a first embodiment of the generator, the microwave output circuit comprises a chamber having an input window for the electrons emitted by the cathodes and an emission window for the microwaves produced by the variations in the electron density in the extrema regions of the electromagnetic field in the chamber. This structure is based on that of a “conventional vircator”.

In another embodiment of the microwave generator providing a high efficiency, the microwave circuit comprises, on the emitter side, an excitation waveguide followed by an output resonant cavity. The signal generated in the waveguide, which excites the resonant cavity, modulates the energy of the electron beam. This other structure is based on that of a “feedback vircator” (FV).

The invention will be more clearly understood by means of illustrative examples of virtual cathode microwave generators with reference to the appended drawings, in which:

FIGS. 1a and 1b, already described, show two sectional views of a virtual-cathode microwave generator (or vircator) of the prior art;

FIG. 1c, already described, shows the electromagnetic fields in a plane passing through the axis of revolution of the cavity of the microwave generator of FIG. 1a;

FIG. 2, already described, shows a diagram explaining the principle of a feedback virtual-athode microwave generator (FV) of the prior art;

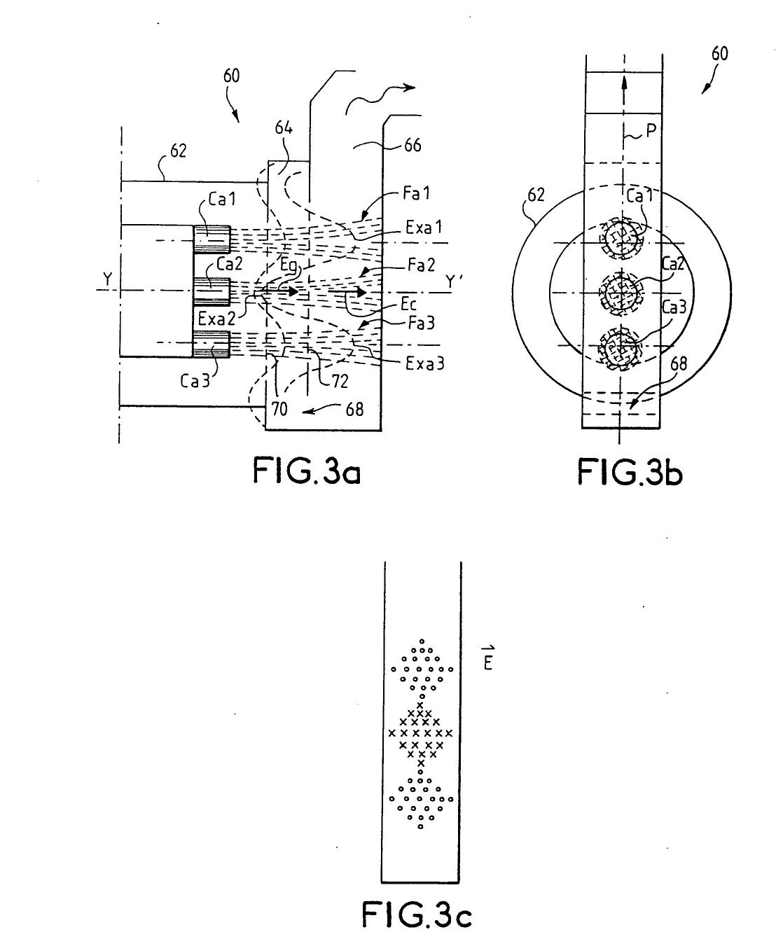

FIG. 3a shows a multibeam FV according to the invention;

FIG. 3b shows a front view of the vircator of FIG. 3a according to the invention;

FIG. 3c shows the distribution of the electric field in the microwave circuit of the vircator of FIG. 3b;

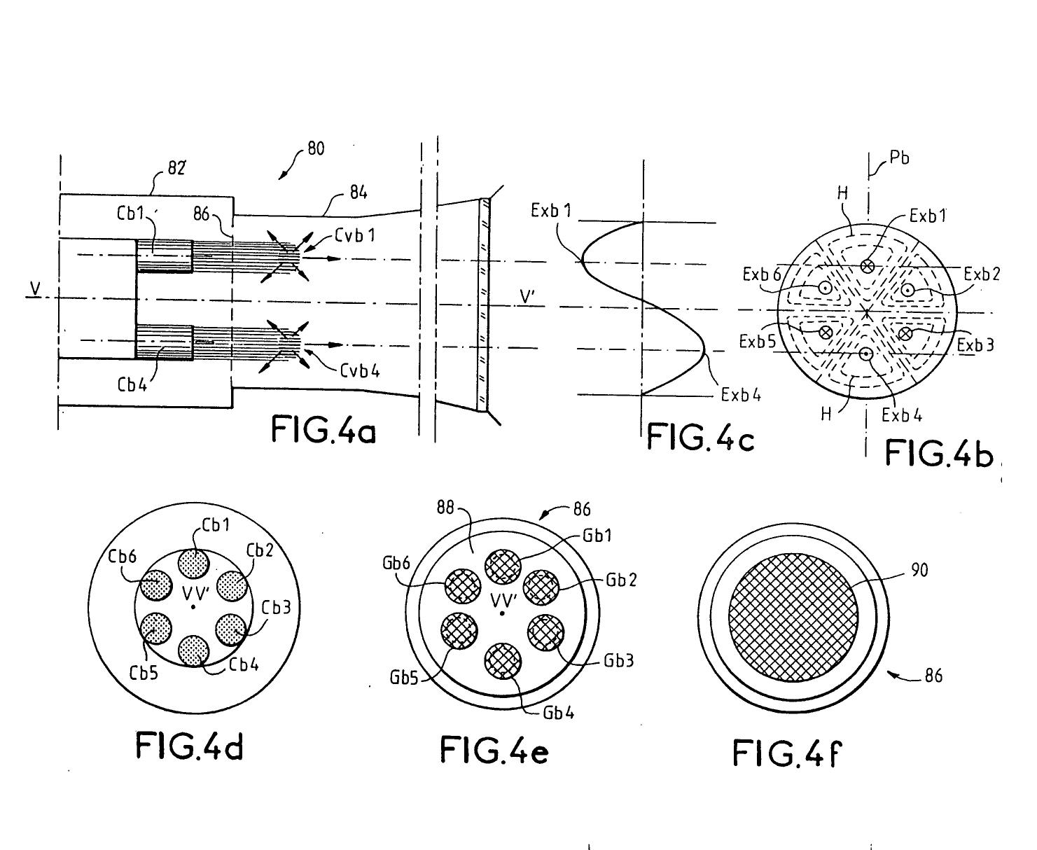

FIG. 4a shows an illustrative example of a conventional-type vircator, according to the invention, having six electron beams;

FIG. 4b shows the magnetic field lines H and the electric field lines E of the vircator of FIG. 4a;

FIG. 4c shows the variation in a plane of the electric field E in the chamber of the vircator of FIG. 4a;

FIG. 4d shows a front view of the electron gun of the vircator of FIG. 4a;

FIGS. 4e and 4f show grids of the vircator of FIG. 4a;

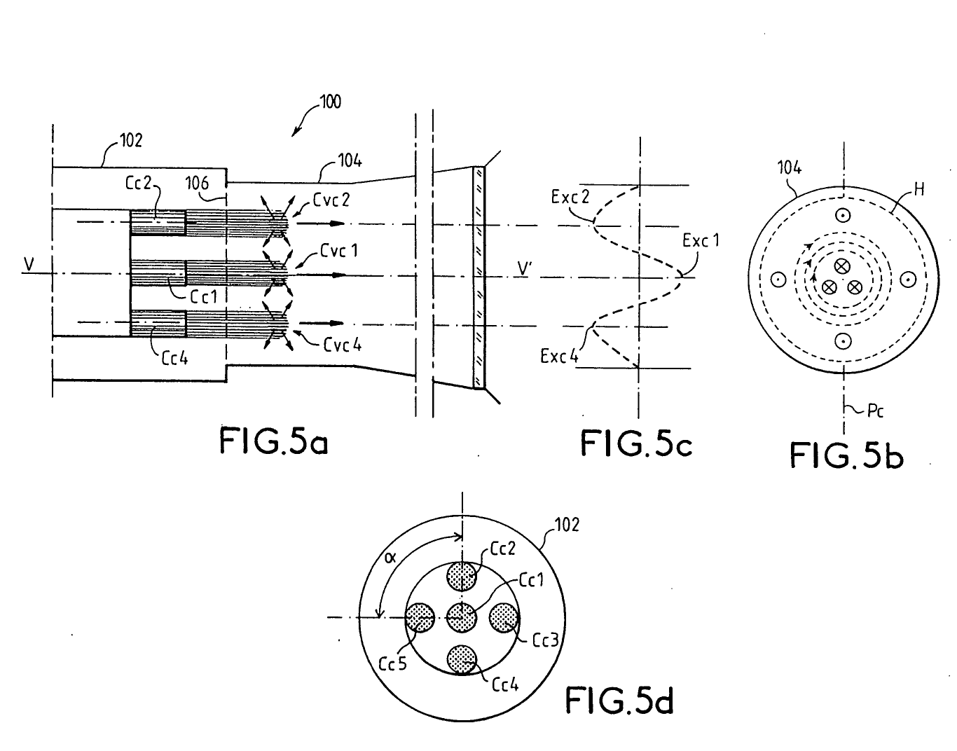

FIG. 5a shows an illustrative example of a conventional vircator according to the invention with five electron beams;

FIG. 5b shows the magnetic field lines H and the electric field lines E of the vircator of FIG. 5a;

FIG. 5c shows the variation in a plane of the field E in the chamber of the vircator of FIG. 5a;

FIG. 5d shows a front view of the electron gun of the vircator of FIG. 5a;

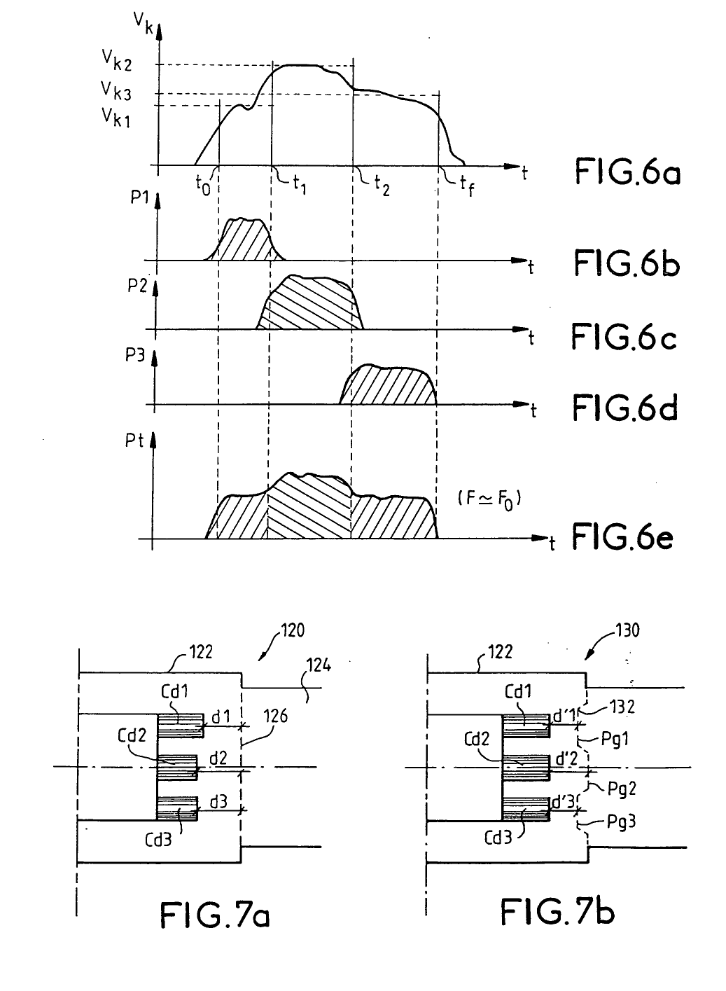

FIG. 6a shows an example of the variation of the voltage pulse Vₖ of a vircator as a function of time;

FIGS. 6b, 6c and 6d show the respective microwave power levels delivered over time by the three cathodes of a vircator according to the invention; and

FIGS. 7a and 7b show two embodiments of the multibeam vircator according to the invention having different cathode/grid distances.

In the vircator of the prior art shown in FIG. 2, the tube comprises a resonant cavity 32 in the form of a rectangular waveguide of low height (approximately ⅙ of the width) and with a length of 3λ/2 (λ being the wavelength of the oscillation in the vircator). The electron beam passes through the center of the cavity along an electric field antinode. Only one third of the capacity of the cavity is therefore used to modulate the beam. The solution proposed according to a main feature of the invention consists in making an electron beam pass into each electric field antinode of the cavity. Such a cavity may be called a multibeam vircator (MBV).

FIG. 3a shows a multibeam FV 60 according to the idea explained above. The multibeam FV 60 comprises a high-voltage gun 62 comprising three cylindrical cathodes Ca1, Ca2, Ca3, the axes of revolution of which lie in the same plane P.

Like the FV 30 of the prior art shown in FIG. 2, the multibeam FV according to the invention comprises an excitation waveguide 64 coupled to a resonant cavity 66 through a passage 68 between the waveguide and the cavity.

Each of the electron beams Fa1, Fa2, Fa3 emanating from the cathodes Ca1, Ca2, Ca3 pass through one of the respective electric field extrema Exa1, Exa2, Exa3 that exist in the waveguide and the resonant cavity.

The excitation waveguide 64 is bounded by a first grid 70 on the side facing the high-voltage gun 62 and by a second grid 72 on the side facing the cavity. The excitation waveguide 64 resonates at 5λ/2, as does the output cavity (operation could also take place with a resonance at 3λ/2). The electric fields in the excitation waveguide Eg and in the resonant cavity Ec have, in this resonant mode example, one extremum along an axis YY′ of the gun in the electron emission direction and a second extremum of circular shape around this axis. In FIG. 3a, the variations in the fields Eg and Ec in the plane P of the cathodes Ca1, Ca2 and Ca3 passing through the YY′ axis of the gun are shown by the dotted lines.

The central beam Fa2 excites the field along the YY′ axis of the tube in phase opposition with the two adjacent beams Fa1 and Fa3. But this is the normal operation of a multibeam tube, which counts given the phase coherence of the combination of the two resonant circuits.

FIG. 3b shows a front view of the vircator of FIG. 3a according to the invention, showing the position of the cathodes in the plane P passing through the axis of the central beam F2, and FIG. 3c shows an electric field distribution in the waveguide and in the cavity, seen from the front.

FIG. 3a clearly shows several cathodes supplied in parallel via the rear, a single anode with several “gridded” passages facing the cathodes, and the extrema Exa1, Exa2, Exa3 of the electric fields E in the chamber.

It should be noted that the anode 70 may be “gridded” over its entire area, the essential point being that the grid thus formed does not let the HF generated pass into the chamber.

However, this concept of several electron beams in the field extrema may very well apply to a conventional vircator having an output chamber. In this case, the notion of resonance is in particular applied to the “anode (or grid)/virtual cathode” space, that is to say to the output chamber.

FIG. 4a shows an illustrative example of a conventional vircator 80 with six electron beams operating in a TM₃₁₀-type resonant mode.

The vircator 80 comprises an electron gun 82 and a chamber 84 separated from the gun by a gridded anode 86. The gun comprises six cathodes Cb1, Cb2, Cb3, Cb4, Cb5 and Cb6 distributed uniformly around an axis of revolution VV′ of the cylindrical chamber 84 with an angular pitch of 60 degrees and at the same distance from the axis VV′ of the chamber.

FIG. 4b shows the magnetic field lines H and the electric field lines E for the TM₃₁₀ mode in a plane perpendicular to the VV′ axis. The fields E exhibit extrema Exb1, Exb2, Exb3, Exb4, Exb5 and Exb6 that change sign at each 60-degree angular shift around the VV′ axis. It should be noted that the two directions (or signs) of the fields are shown by a cross and by a dot in a circle, respectively.

FIG. 4c shows the variation in the field E in the chamber, in a plane Pb passing, on the one hand, through its axis of revolution VV′ and, on the other hand, through the axes of two cathodes Cb1 and Cb4 located on either side of this axis VV′ of revolution. In this plane Pb may be seen two extrema Exb1 and Exb4 of opposite sign on either side of the axis of revolution VV′, and this field configuration is repeated, the sign changing every 60 degrees corresponding to the angular shift a between the cathodes.

Each electron beam of sufficient intensity, emanating from each of the cathodes Cb1 to Cb6, produces a virtual cathode in the chamber. FIG. 4a shows the two virtual cathodes Cvb1 and Cvb2 produced by the beams emanating from the cathodes Cb1 and Cb2, respectively.

FIG. 4d shows a front view of the electron gun 82 having the six cathodes around the VV′ axis.

The gridded anode 86 may be formed either, as shown in FIG. 4e, by a plate 88 having one circular grid Gb1, Gb2, Gb3, Gb4, Gb5 and Gb6 per cathode, each grid facing its respective cathode, or, as shown in FIG. 4f, by a single circular grid 90 for all the cathodes.

FIG. 5a shows another illustrative example of a vircator 100 of the conventional type, operating in a TM₀₂₀-type resonant mode.

The vircator 100 comprises an electron gun 102 and a cylindrical chamber 104 separated from the gun by a gridded anode 106. The gun comprises five cathodes—a central cathode Cc1 along the VV′ axis of the chamber and four cathodes Cc2, Cc3, Cc4 and Cc5 arranged at an equidistant from the central cathode Cc1 with an angular pitch α of 90 degrees.

FIG. 5b shows the magnetic field lines H and electric field lines E for the TM₀₂₀ mode in a plane perpendicular to the VV′ axis. The electric fields E exhibit a central extremum Exc1 on the VV′ axis of the chamber and an annular extremum that is constant around a circumference, but of opposite sign.

FIG. 5c shows the variation in the field E in the chamber, in a plane Pc passing, on the one hand, through its axis of revolution VV′ and, on the other hand, through the axes of two cathodes Cc1 and Cc4 located on either side of the central cathode Cc1. In this plane Pc, two extrema Exc2 and Exc4 of the same sign appear on either side of the central extremum Exc1 of opposite sign.

As in the previous embodiments, each electron beam of sufficient intensity, emanating from each of the cathodes Cc1 to Cc5, produces a virtual cathode in the chamber. FIG. 5a shows three of the five virtual cathodes—a central virtual cathode Cvc1 and two virtual cathodes Cvc2 and Cvc4 produced by the beams emanating from the central cathode Cc1 and from two cathodes Cc2 and Cc4, respectively, lying in the same plane Pc.

As in the case of the embodiment shown in FIG. 4a, the gridded anode 106 may be formed either by a plate having one circular grid per cathode, each grid facing its respective cathode, or by a single circular grid for all the cathodes.

It is therefore always the case that the variations in the cathode voltage Vₖ that are inherent in these large machines consisting of the modulator (Vₖ·Iₖ)/vircator (microwave oscillator)/antenna (microwave radiation) assemblies, mean that the electron oscillation frequency does not correspond to the resonant frequency F₀ of the desired mode of the chamber over the entire voltage pulse width. It follows that the electromagnetic radiation cannot be produced over the entire voltage pulse. The microwave pulse is therefore singularly shorter than the cathode voltage pulse Vₖ.

To be specific, the operating frequency, that is to say the frequency of the electron oscillations or those of the virtual cathode, depends enormously on the high voltage Vₖ applied between cathode and grid (or anode). When the cathode voltage Vₖ increases, the oscillation frequency in the chamber of the vircator increases as V^{α}ₖ, where ½≦α≦¼.

FIG. 6a shows an example of how the voltage pulse Vₖ varies as a function of time t. The voltage pulse starts at time to and ends at time t_{f}. The voltage Vₖ passes through respective values Vₖ₁, Vₖ₂, Vₖ₃ during successive time periods from t₀ to t₁, from t₁ to t₂ and from t₂ to t_{f}.

According to another feature of the multibeam vircator according to the invention, the distances between the grid (or anode) and the cathodes of the electron gun vary according to the cathode in question, so as to compensate for the variations in the oscillation frequency of the vircator that are due to the variations in the cathode voltage over the course of the voltage pulse Vₖ.

Thus, a variation of the voltage Vₖ in one direction results in electron emission by at least one of the cathodes of the gun, the distance of which from the grid would be such that the oscillation occurs at the desired resonant frequency F₀. For example, an increase in the voltage Vₖ would result in emission by a cathode closer to the grid at the desired frequency, whereas a decrease in the voltage Vₖ would produce emission at the same frequency by a cathode further away from the grid.

If the voltage pulse Vₖ has n voltage plateaux over time and if dki is the distance between a cathode Cki (or group of cathodes) and the grid, where i=1, 2, . . . n, by keeping the V^{α}ₖ/dki ratio constant for each cathode or group of cathodes, the oscillation frequency is kept constant through the voltage pulse.

The idea is to produce an electron gun having cathodes whose distances from the grid are such that the V^{α}ₖ/dki ratio remains constant at the closure by the plasma of the space between cathode and anode for at least one cathode of the gun, during at least part of the voltage pulse.

FIGS. 7a and 7b show two embodiments of the multibeam vircator according to the invention having different cathode/grid distances.

Let us consider the voltage pulse Vₖ as being that shown in FIG. 6a, which has three voltages over time. In the first embodiment shown in FIG. 7a, a vircator 120 has an electron gun 122 that emits three electron beams in a resonant chamber 124 separated from the gun by a grid 126. The gun comprises three cathodes Cd1, Cd2, Cd3, the respective distances d1, d2 and d3 of which from the grid 126 are such that the V^{α}ₖ/dki ratio for each of the cathodes remains constant. For this purpose, d1 will be set so as to obtain the resonant frequency F₀ at the voltage Vₖ₁, d2 will be set so as to obtain F₀ for Vₖ₂ and d3 will be set so as to obtain F₀ for Vₖ₃.

FIGS. 6b, 6c and 6d show the respective microwave powers P1, P2 and P3 delivered by the three cathodes over time. The first cathode delivers the power P1 at the frequency F₀ during the time when the pulse is at Vₖ₁, the second during the time when the pulse is at Vₖ₂ and the third during the time when the pulse is at Vₖ₃. FIG. 6e shows the total microwave pulse delivered by the vircator at the resonant frequency F₀ with a width much larger than that obtained by the vircators of the prior art, substantially the width of the voltage pulse Vₖ.

In the second embodiment of a vircator 130 shown in FIG. 7b, the ends of the cathodes Cd1, Cd2 and Cd3 lie in the same plane and a grid 132 of the chamber comprises areas Pg1, Pg2 and Pg3 facing the cathodes Cd1, Cd2 and Cd3 at a greater or lesser distance from the cathodes so as to obtain various grid/cathode distances d′1, d′2 and d′3.

In practice, it is possible to imagine not three beams but more, for example five beams as in the gun shown in FIG. 5d. In this case, the cathodes are combined to form only three groups, or rather as many groups as there are divisions of the voltage pulse Vₖ.

In these various embodiments, the emissive surfaces will be chosen to create the currents and the power needed for each of the pulse divisions.

The vircator according to the invention has many advantages over the vircator of the prior art, among which we may mention the following:

an increased microwave power, for the same high voltage;

an identical microwave power for a lower high voltage, and therefore with less “breakdown” limitation of the pulse width;

a lower impedance Z (=Vₖ/Iₖ) and, in certain cases, better matching between the electrical generator Vₖ·Iₖ and the vircator, hence a higher overall generator/vircator efficiency, better stability and a wider pulse; and

excitation of the resonant mode over several of its electric field maxima, and therefore a lower probability of inducing resonance in other “parasitic” modes. Hence, more rapid oscillation start-up and better pulse stability.

1. A microwave generator comprising:
an emitter capable of producing electrons in a microwave output circuit the quantity of electrons emitted being sufficient to cause a regular variation in the electron density in the output microwave circuit, the circuit converting the kinetic energy of the electrons into microwave energy in a resonant mode, the electron emitter emits the electrons in several regions of the microwave circuit that exhibit field extrema of the resonant mode.

2. The microwave generator as claimed in claim 1, wherein the emitter is an electron gun comprising several cathodes so as to produce several electron beams, each of the beams being emitted in a field extremum region of the resonant mode of the microwave circuit.

3. The microwave generator as claimed in claim 2, wherein the microwave circuit comprises, on the emitter side, an excitation waveguide followed by an output resonant cavity, the signal generated in the waveguide, which excites the resonant cavity, modulating the energy of the electron beam.

4. The microwave generator as claimed in claim 3, wherein the gun comprises three cylindrical cathodes, the axes of revolution of which lie in the same plane P, each of the electron beams emanating from the cathodes passing through one of the respective electric field extrema existing in the waveguide and the resonant cavity.

5. The microwave generator as claimed in claim 2, wherein the output microwave circuit comprises a chamber having an input window for the electrons emitted by the cathodes and an emission window for the microwaves produced by the variations in the electron density in the extrema regions of the electromagnetic field in the chamber.

6. The microwave generator as claimed in claim 5, further comprising an electron gun and a chamber separated from the gun by a gridded anode, the gun comprising six cathodes distributed uniformly around an axis of revolution VV′ of the cylindrical chamber with a 60-degree angular pitch and at the same distance from the axis VV′ of the cavity.

7. The microwave generator as claimed in claim 6, wherein said microwave generator operates in a TM₃₁₀-type resonant mode.

8. The microwave generator as claimed in claim 6, wherein the gridded anode may be formed either by a plate having one circular grid per cathode, each grid facing its respective cathode, or by a single circular grid for all the cathodes.

9. The microwave generator as claimed in claim 5, comprising and electron gum and a circular chamber separated from the gun by a gridded anode, the gun comprising five cathodes, a central cathode on the VV′ axis of the chamber and four cathodes arranged at an equal distance from the central cathode with an angular pitch α of 90 degrees.

10. The microwave generator as claimed in claim 9, wherein said microwave generator operates in a TM₀₂₀-type resonant mode.

11. The microwave generator as claimed in claim 2, wherein the distances between the grid (or anode) and the cathodes of the electron gun vary according to the cathode in question so as to compensate for the variations in the oscillation frequency of the generator that are due to the variations in a cathode voltage pulse Vₖ.

12. The microwave generator as claimed in claim 11, wherein the ends of the cathodes lie in the same plane and a grid of the chamber comprises areas facing the cathodes at a greater or lesser distance from the cathodes so as to obtain various grid/cathode distances.

13. The microwave generator as claimed in claim 7, wherein the gridded anode may be formed either by a plate having one circular grid per cathode, each grid facing its respective cathode, or by a single circular grid for all the cathodes.

14. The microwave generator as claimed in claim 3, wherein the distances between the grid (or anode) and the cathodes of the electron gun vary according to the cathode in question so as to compensate for the variations in the oscillation frequency of the generator that are due to the variations in a cathode voltage pulse Vₖ.

15. The microwave generator as claimed in claim 4, wherein the distances between the grid (or anode) and the cathodes of the electron gun vary according to the cathode in question so as to compensate for the variations in the oscillation frequency of the generator that are due to the variations in a cathode voltage pulse Vₖ.

16. The microwave generator as claimed in claim 5, wherein the distances between the grid (or anode) and the cathodes of the electron gun vary according to the cathode in question so as to compensate for the variations in the oscillation frequency of the generator that are due to the variations in a cathode voltage pulse Vₖ.

17. The microwave generator as claimed in claim 6, wherein the distances between the grid (or anode) and the cathodes of the electron gun vary according to the cathode in question so as to compensate for the variations in the oscillation frequency of the generator that are due to the variations in a cathode voltage pulse Vₖ.

18. The microwave generator as claimed in claim 7, wherein the distances between the grid (or anode) and the cathodes of the electron gun vary according to the cathode in question so as to compensate for the variations in the oscillation frequency of the generator that are due to the variations in a cathode voltage pulse Vₖ.

19. The microwave generator as claimed in claim 8, wherein the distances between the grid (or anode) and the cathodes of the electron gun vary according to the cathode in question so as to compensate for the variations in the oscillation frequency of the generator that are due to the variations in a cathode voltage pulse Vₖ.
